(19) United States
(12) Patent Application Publication
(10) Pub. No.: US 2011/0031879 A1
(43) Pub. Date: Feb. 10, 2011

(54) STREET LIGHTING LAMP WITH LONG LIFE, HIGH EFFICIENCY, AND HIGH LUMEN MAINTENANCE

(75) Inventors: Timthoy David Russell, North Ridgeville, OH (US); Gergely Ormandlaky, Pecs (HU); Gabor Mikovics, Budapest (HU)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/538,198

(22) Filed: Aug. 10, 2009

(51) Int. Cl. H01J 61/22; H01J 9/395

(52) U.S. Cl. 313/638; 445/26

(57) ABSTRACT

A lamp includes a discharge vessel and electrodes extending into the discharge vessel. The lamp further includes an ionizable fill sealed within the vessel. The fill includes an inert gas and a halide component. The halide component includes a sodium halide, a thallium halide, at least one of a calcium halide and a strontium halide, and at least one of a rare earth halide. The rare earth halide is selected from the group consisting of lanthanum, cerium, praseodymium, samarium and neodymium, and combinations thereof.

### BACKGROUND OF THE DISCLOSURE

The present disclosure relates to a discharge lamp, and more specifically to a High Intensity Discharge (HID) metal halide lamp made of transparent ceramic arc chamber materials. The HID lamp finds particular application in street-lighting, although it will be appreciated that selected aspects may find application in related discharge lamp environments encountering the same issues with regard to lumen efficacy and lumen maintenance.

High Intensity Discharge (HID) lamps are high-efficiency lamps that can generate large amounts of light from a relatively small source. These lamps are widely used in many applications, including highway and road lighting, lighting of large venues such as sports stadiums, floodlighting of buildings, shops, industrial buildings, and projectors, to name but a few. The term “HID lamp” is used to denote different kinds of lamps. These include mercury vapor lamps, metal halide lamps, and sodium lamps. Metal halide lamps, in particular, are widely used in areas that require a high level of brightness at relatively low cost. HID lamps differ from other lamps because their functioning environment requires operation at high temperature and high pressure over a prolonged period of time. Also, due to their usage and cost, it is desirable that these HID lamps have relatively long useful lives and produce a consistent level of brightness and color of light. Although in principle, HID lamps can operate with either an alternating current (AC) supply or a direct-current (DC) supply, in practice, the lamps are usually driven via an AC supply.

Discharge lamps produce light by ionizing a vapor fill material, such as a mixture of rare gases, metal halides and mercury with an electric arc passing between two electrodes. The electrodes and the fill material are sealed within a translucent or transparent discharge vessel that maintains the pressure of the energized fill material and allows the emitted light to pass through it. The fill material, also known as a “dose,” emits a desired spectral energy distribution in response to being excited by the electric arc. For example, halides provide spectral energy distributions that offer a broad choice of light properties, e.g. color temperatures, color renderings, and luminous efficacies.

With current technology, if the ratio between the distance separating the electrodes in the discharge vessel to the diameter of the chamber is less than four, the relative abundance of sodium between the arc and the discharge chamber walls produces greater absorption of generated light radiation by such sodium due to its absorption lines near the peak values of visible light. Additionally, if the ratio is less than five, the lamp being operated in a horizontal position, results in the arc established in the arc discharge chamber substantially bending upward due to the buoyancy of its vaporized chamber constituents. The upward bending of the arc draws it closer to the wall of the arc discharge chamber raising the temperature of the wall in that vicinity. Such temperature increases can reduce the operating life of the lamp when operated horizontally.

Therefore, it would not be obvious to a person skilled in the art for a lamp to achieve higher efficacies and better color performance having as aspect ratio of less than 4.0 with an operating voltage of less than 110.

Unexpectedly, the present invention achieves greater than about 110 lumens per watt (LPW) initially, at least about 80% lumen maintenance at 12,000 hours and a color rendering index (Ra) of about greater than 65, with less than about 5 mg of mercury present These benefits are achieved through a combination of an aspect ratio of greater than about 2.5 and less than about 4.0, a ratio of sodium to rare earth of greater than about 20 and less than about 40, a dose composition of sodium halide, a calcium halide, thallium halide, and lanthanum halide, and a tungsten-oxygen cycle.

### SUMMARY OF THE DISCLOSURE

In an exemplary embodiment, a lamp includes a discharge vessel and electrodes extending into the discharge vessel. The vessel further includes an ionizable fill sealed within the vessel. The ionizable fill includes at least an inert gas and a halide fill. The halide fill includes a sodium halide, a thallium halide, at least one of a calcium halide and a strontium halide, and at least one of a rare earth halide selected from the group consisting of lanthanum, cerium, praseodymium, samarium, and neodymium, and combinations thereof.

In one embodiment of the invention, the foregoing combination includes lanthanum halide as the rare earth component.

According to the invention, the aspect ratio of the discharge tube is satisfied by:

2.0<EA/Di<4.8
where EA=a distance between the electrodes, and
Di=an inner diameter of the discharge vessel.

In another embodiment of the invention, the molar ratio of sodium halide to rare earth halide in the fill is satisfied by: 16≦Na/RE≦48.

In yet another embodiment of the invention, a method of forming a lamp is provided. The method includes providing a discharge vessel having sealed therein, an ionizing fill, this fill including an inert gas and a halide component. The halide component includes a sodium halide, a thallium halide, at least one of a calcium halide and a strontium halide and at least one of a rare earth halide selected from the group consisting of lanthanum, cerium, praseodymium, samarium, and neodymium. The method further includes positioning electrodes within the discharge vessel to energize the fill in response to a voltage applied thereto. It may be appreciated the current invention is not limited to any particular manufacturing method or processing.

A primary benefit realized by the lamp according to the invention is high efficiency due to the combination of aspect ratio (AR) and wall loading.

Another benefit realized by the lamp according to the invention is high efficiency due to dose composition and the amount of that dose that is added to the discharge vessel.

Still another benefit of the lamp according to the invention is high percent lumen maintenance due to the establishment of a tungsten-halogen wall cleaning cycle preventing tungsten from deposition on the translucent wall of the discharge vessel.

Further still another benefit of the lamp according to the invention is high percent lumen maintenance due to maintaining a long separation distance between the electrode tips (EA) wherein a large percent of the translucent ceramic walls do not receive any deposited tungsten thereby reducing wall blackening.

Still another benefit of the lamp according to the invention is a long life due to dose composition and dose weight added to the discharge vessel.

Still other features and benefits of the lamp according to the invention will become more apparent from reading and understanding the following detailed description.

### BRIEF DESCRIPTION OF THE DRAWINGS

FIG. 1 is a cross-sectional view of an HID lamp according to the exemplary embodiment;

FIG. 2 illustrates a theoretical plot of aspect ratio versus lumens per watt (LPW) according to the exemplary embodiment;

FIG. 3 illustrate a theoretical plot of sodium to rare earth ratio (Na/RE) versus lumen per watt (LPW) according to the exemplary embodiment; and

FIG. 4 illustrates a theoretical plot of the solubility of a tungsten species versus temperature for 0.025 mg of WO₃ as a source of oxygen according to the exemplary embodiment.

### DETAILED DESCRIPTION OF THE PREFERRED EMBODIMENTS

The invention provides a lamp exhibiting a combination of an aspect ratio of greater than about 2.5 and less than about 4.0, a ratio of sodium to rare earth of greater than about 20 and less than about 40, a dose composition of sodium halide, calcium halide, thallium halide, and lanthanum halide, and an oxygen cycle. This lamp provides for a high intensity discharge lamp having higher efficacies and better color performance than other similar lamps currently available.

Aspects of the exemplary embodiment relate to a lamp that includes a discharge vessel and electrodes extending into the discharge vessel. The lamp further includes an ionizable fill sealed within the vessel. The ionizable fill includes an inert gas and a halide component. The halide component includes a sodium halide, a thallium halide, at least one of a calcium halide and a strontium halide, and at least one of a rare earth halide selected from the group consisting of lanthanum, cerium, praseodymium, samarium, and neodymium, and combinations thereof.

The exemplary embodiment provides a white light, high color rendering index (Ra) lamp with 110 lumens per watt (LPW) and 80% lumen maintenance at 12,000 hours. It allows metal halide lamps to compete with High Pressure Sodium (HPS) lamps for street-lighting applications. It may be appreciated that these metal halide lamps would not be limited to street-lighting applications, but also to city beautification lighting and urban lighting due to their high Ra and white light.

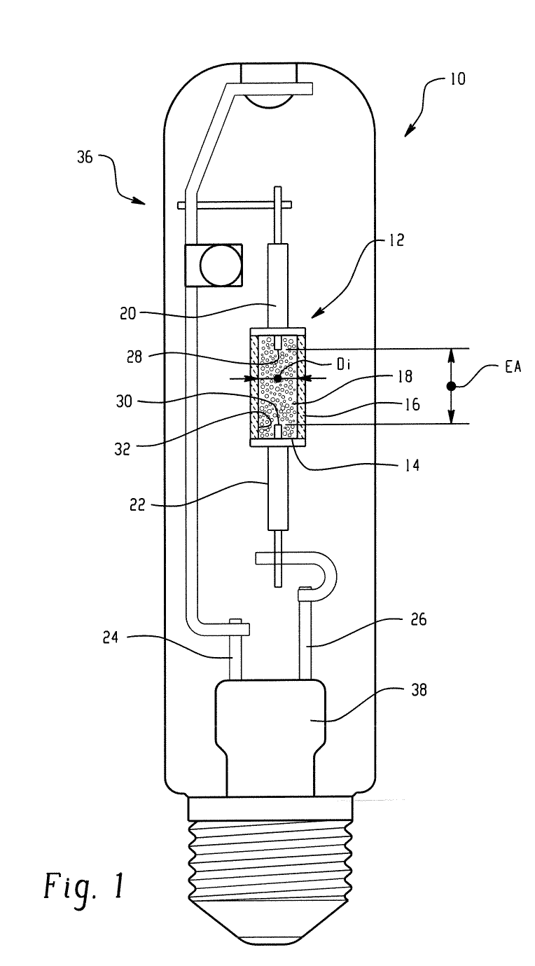

With reference to FIG. 1, a cross-sectional view of an exemplary HID lamp 10 is shown. The lamp includes a discharge vessel or arc tube 12, which defines an interior chamber 14. The discharge vessel 12 has a wall 16, which may be formed of a ceramic material, such as alumina, or other suitable light-transmissive material. The exemplary discharge vessel 14 is formed of a high temperature resistant, light permeable material formed as a single component. The discharge vessel 14 may be coated with a or infrared reflective coating as appropriate. The exemplary lamp 12 may be a high intensity discharge (HID) lamp, which operates at wattage of at least about 45 W and in one embodiment, at least about 200 W, e.g., up to about 250 W. The lamp is supplied with current by a circuit (not shown) connected with a source of AC power. The lamp may be designed to run on low frequency square wave electronic ballast. Alternatively the lamp may run on an electromagnetic ballast.

An ionizable fill 18 is sealed in the interior chamber 14. Electrodes 20, 22, which may be formed from tungsten, are positioned at opposite ends of the discharge vessel so as to energize the fill when an electric current is applied thereto. The two electrodes 20 and 22 are typically fed with an alternating electric current via conductors 24, 26 (e.g., from a ballast, not shown). Tips 28, 30 of the electrodes 20, 22 are spaced by a distance EA which defines the arc gap. It will be appreciated that other known electrode materials may alternatively be used.

When the lamp 10 is powered, indicating a flow of current to the lamp, a voltage difference is created across the two electrodes. This voltage difference causes an arc across the gap between the tips 28, 30 of the electrodes. The arc results in a plasma discharge in the region between the electrode tips 28, 30. Visible light is generated and passes out of the chamber 14, through the wall 16.

The electrodes become heated during lamp operation and tungsten tends to vaporize from the tips 28, 30. Some of the vaporized tungsten may deposit on an interior surface 32 of wall 16. Absent a regeneration cycle, the deposited tungsten may lead to wall blackening and a reduction in the transmission of the visible light which ultimately reduces useful lamp life.

The electrode tip separation EA is the distance between the electrode tips 28, 30. The EA for a 50 W embodiment as measured along the lamp axis X can be, for example, from about 8 mm to about 15 mm, e.g., about 8 mm to about 12 mm, and in one embodiment, about 10 mm. For a 70 W lamp embodiment, EA as measured along the lamp axis X can be, for example, from about 10 mm to about 15 mm, e.g., about 10 mm to about 14 mm, and in one embodiment, about 11 mm. For a 100 W embodiment, EA as measured along the lamp axis X can be, for example, from about 13 mm to about 24 cm, e.g., about 14 mm to about 20 mm, and in one embodiment, about 18 mm. For a 150 W lamp embodiment, EA as measured along the lamp axis X can be, for example, from about 15 mm to about 25 mm, e.g., about 15 mm to about 22 mm, and in one embodiment, about 19 mm.

The arctube diameter Di is the internal diameter of the arctube, measured in a region between the electrodes 28, 30. The Di for a 50 W embodiment, for example, Di can be for example, from about 3.5 mm to about 4 mm, e.g., about 3.6 mm to about 4.0 mm, and in one embodiment, about 3.8 mm. For a 70 W embodiment, for example, Di can be for example, from about 3.5 mm to about 5 mm, e.g., about 3.8 mm to about 4.9 mm, and in one embodiment, about 4.75 mm. For a 100 W embodiment, for example, from about 4.2 mm to about 5.5 mm, e.g., about 4.6 mm to about 5.4 mm, and in one embodiment, about 4.8 mm. For a 150 W embodiment, for example, Di can be for example, from about 5 mm to about 7 mm, e.g., about 5.5 mm to about 7.0 mm, and in one embodiment, about 6.3 mm.

According to the present invention, a lamp is provided having an aspect ratio AR that, along with the fill and dosage requirements set forth herein, exhibits unexpected performance advantages. The aspect ratio (EA/Di) is defined as the ratio of electrode tip separation EA divided by the internal arctube diameter Di. In one embodiment, the aspect ratio of the discharge tube according to the invention is satisfied by, for example, 2.0<EA/Di<4.8, and in another embodiment by, 2.5<EA/Di<4.0.

Lumens (lm), as used herein, refer to the SI unit of luminous flux, a measure of the perceived power of light. If a light source emits one candela of luminous intensity into a solid angle of one steradian, the total luminous flux emitted into that solid angle is one lumen. Put another way, an isotropic one-candela light source emits a total luminous flux of exactly 4π lumens. The lumen can be considered as a measure of the total “amount” of visible light emitted. The output of a lamp can be defined in terms of lumens per Watt (LPW).

In one embodiment the lumens per watt (LPW) of the exemplary lamp at 12,000 hours of operation is at least 80, and in one specific embodiment, at least about 88 or at about 10 at 100 hours for a lamp using an electronic ballast. In another embodiment the lumens per watt (LPW) of the exemplary lamp at 12,000 hours of operation is at least 80, and in one specific embodiment, at least about 88 or at about 105 at 100 hours for a lamp using an electromagnetic ballast.

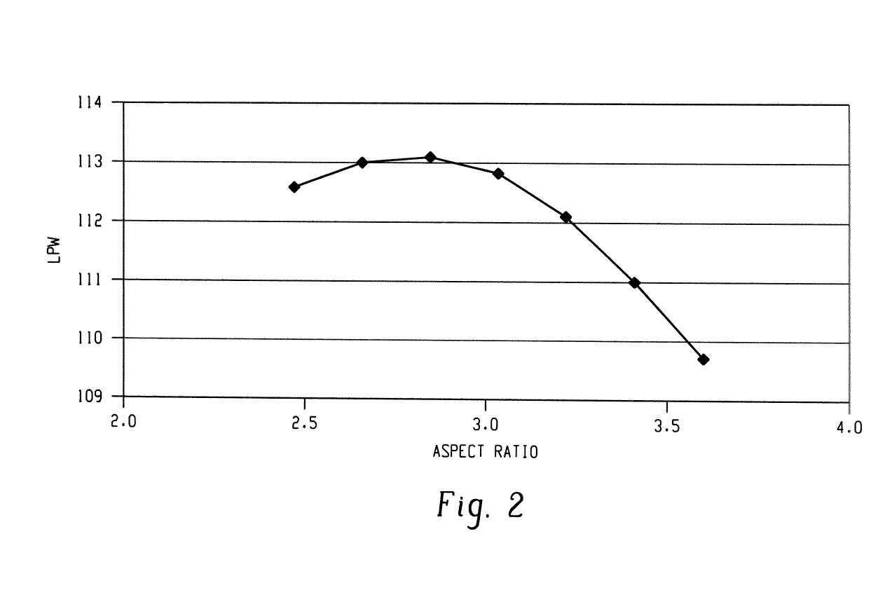

FIG. 2 is a plot for a 100 W lamp of aspect ratio (AR) versus lumens per watt (LPW), based on a statistical model from experimental data. FIG. 2 illustrates a maximum LPW of 113 at an aspect ratio of about 2.8. The EA for the lamp was about 15.66 mm and the Di about 5.45 mm. Thus, the maximum LPW occurs at an aspect ratio of less than 4.0.

As used herein, “Arctube Wall Loading” (WL) is the arctube power (watts) divided by the arctube surface area (square mm). For purposes of calculating WL, the surface area is the total internal surface area and the arctube power is the total arctube power including electrode power. According to the invention, WL can be ≦33 W/cm². In one embodiment, the wall loading is from about 20 to 33 W/cm², for example, about 33 W/cm². In general, the fill and wall loading are sufficient to maintain a external wall temperature of at least about 1100K, e.g., 1100-1525K.

Higher efficiency of the lamp according to the invention is in one exemplary embodiment achieved due to the combination of aspect ratio (AR) and wall loading. Too long of an aspect ratio, i.e. >4.0, may lead to a low wall loading and insufficient vapor pressure of the metal halide additives. Conversely, a too short aspect ratio, i.e. <2.5, may lead to a high wall loading and a higher metal halide additive vapor pressure causing a reduction in lumens.

The interior space 14 has a volume commensurate with the operating voltage of the lamp and sustainable wall loading. For example, for a 50 W lamp, the volume may be about 0.125 cm³ to about 0.17 cm³, e.g., about 0.15 cm³. For example, for a 70 W lamp, the volume may be about 0.16 cm³ to about 0.26 cm³, e.g., about 0.22 cm³. For example, for a 100 W lamp, the volume may be about 0.26 cm³ to about 0.54 cm³, e.g., about 0.40 cm³. For example, for a 150 W lamp, the volume may be about 0.5 cm³ to about 0.9 cm³, e.g., about 0.7 cm³.

The ionizable fill 18 includes an inert gas, free mercury (Hg), a halide component, and a source of available oxygen. The components of the fill 18 and their respective amounts are selected to provide the available oxygen at the wall surface 32 for reaction with any tungsten deposited there. The halide component includes a rare earth halide and may further include one or more of an alkali metal halide, an alkaline earth metal halide, and a Group IIIa halide (indium or thallium). In operation, the electrodes 20, 22 produce an arc between tips 28, 30 of the electrodes that ionizes the fill to produce a plasma in the discharge space. The emission characteristics of the light produced are dependent, primarily, upon the constituents of the fill material, the voltage across the electrodes, the temperature distribution of the chamber, the pressure in the chamber, and the geometry of the chamber. In the following description of the fill, the amounts of the components refer to the amounts initially sealed in the discharge vessel, i.e., before operation of the lamp, unless otherwise noted.

The buffer gas may be an inert gas, such as argon, xenon, krypton, or combination thereof, and may be present in the fill at from about 2-20 micromoles per cubic centimeter (μmol/cm³) of the interior chamber 14. The buffer gas may also function as a starting gas for generating light during the early stages of lamp operation. In one embodiment, suited to CMH lamps, the lamp is backfilled with Ar. In another embodiment, Xe or Ar with a small addition of Kr85 is used. The radioactive Kr85 provides ionization that assists in starting the lamp. The cold fill pressure may be about 60-300 Torr, although higher cold fill pressures are not excluded. In one embodiment, a cold fill pressure of at least about 120 Torr is used. In another embodiment, the cold fill pressure is up to about 240 Torr. Too high a pressure may compromise starting. Too low a pressure can lead to increased lumen depreciation over life.

The mercury dose may be present at from about 2 to 35 mg/cm³ of the arc tube volume. The mercury weight is adjusted to provide the desired arc tube operating voltage (Vop) for drawing power from the selected ballast.

The halide component may be present at from about 5 to about 80 mg/cm³ of arc tube volume, e.g., about 10-60 mg/cm³. A ratio of halide dose to mercury can be, for example, from about 1:1 to about 10:1, expressed by weight. The halide(s) in the halide component can each be selected from chlorides, bromides, iodides and combinations thereof. In one embodiment, the halides are all iodides. Iodides tend to provide longer lamp life, as corrosion of the arc tube and/or electrodes is lower with iodide components in the fill than with otherwise similar chloride or bromide components. The halide compounds usually will represent stoichiometric relationships.

The rare earth halide of the halide component is one that is selected in type and concentration such that it does not form a stable oxide by reactions with the optional source of oxygen, i.e., forms an unstable oxide. By this it is meant that it permits available oxygen to exist in the fill during lamp operation. Exemplary rare earth halides which form unstable oxides include halides of lanthanum (La), praseodymium (Pr), neodymium (Nd), cerium (Ce), samarium (Sm), and combinations thereof. The rare earth halide(s) of the fill can have the general form REX₃, where RE is selected from La, Pr, Nd, Sm, and Ce, and X is selected from Cl, Br, and I, and combinations thereof. The rare earth halide may be present in the fill at a total concentration of, for example, from about 0.3 to about 13 μmol/cm³. An exemplary rare earth halide from this group is lanthanum halide, which may be present at a molar concentration of at least 2% of the halides in the fill, e.g., at least about 2 mol % of the halides in the fill. In one embodiment, only rare earth halides from this limited group of rare earth halides, sodium iodide, calcium iodide and thallium iodide are present in the fill. The lamp fill thus is substantially free of other rare earth halides, by which it is meant that all other rare earth halides are present in a total amount of no more than about 0.01 μmol/cm³. In particular the fill is free of halides of the following rare earth elements: terbium, dysprosium, holmium, thulium, erbium, ytterbium, lutetium, and yttrium. Other halides which form stable oxides are also not present in the fill, such as scandium halides and magnesium halides.

The alkali metal halide, where present, may be selected from sodium (Na), potassium (K), and cesium (Cs) halides, and combinations thereof. In one specific embodiment, the alkali metal halide includes sodium halide. The alkali metal halide(s) of the fill can have the general form AX, where A is selected from Na, K, and Cs, and X is as defined above, and combinations thereof. The alkali metal halide may be present in the fill at a total concentration of, for example, from about 10 to about 300 mol/cm³.

The alkaline earth metal halide, where present, may be selected from calcium (Ca), and strontium (Sr) halides, and combinations thereof. The alkaline earth metal halide(s) of the fill can have the general form MX₂, where M is selected from Ca, Sr, and X is as defined above, and combinations thereof. In one specific embodiment, the alkaline earth metal halide includes calcium halide. The alkaline earth metal halide may be present in the fill at a total concentration of, for example, from about 3 to about 100 μmol/cm³.

The group IlIa halide, where present, may be selected from thallium (Tl) and indium (In) halides. In one specific embodiment, the group IIIa halide includes thallium halide. The group IIIa halide(s) of the fill may have the general form TIX or InX₃, where and X is as defined above. The group IIIa halide may be present in the fill at a total concentration of, for example, from about 0.15 to 15.0 μmol/cm³.

In one embodiment, the fill comprises:
70.5-75.0 mol % of sodium halide,
20.0-21.5 mol % of calcium halide,
2.0-4.0 mol % of rare earth halide, and
1.0-5.0 mol % of thallium halide.

In one embodiment, a molar ratio of sodium halide to rare earth halide in the fill is satisfied by:

16≦Na/RE≦48
where Na=moles of rare earth halide in the fill, and
Re=moles of rare earth halide in the fill.

In another embodiment, a molar ratio of sodium halide to rare earth halide in the fill is satisfied by: 18≦Na/RE≦36.

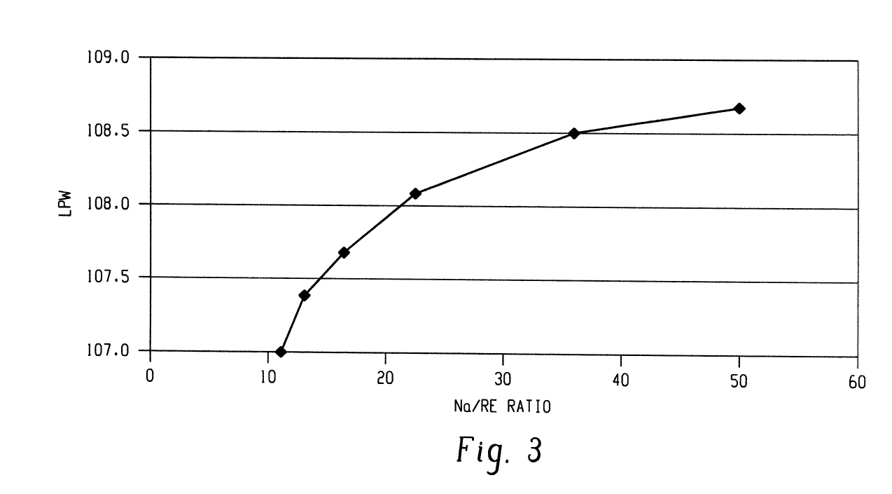

FIG. 3 is a plot for a 100 W lamp of sodium to rare earth halide ratio (Na/RE) versus lumens per watt (LPW), based on a statistical model from experimental data. FIG. 3 illustrates a sodium to rare earth ratio of about 16 having a LPW of 107.6 and a sodium to rare earth ratio of about 48 having a LPW of 108.6 at which the plot begins to level to a maximum. The EA for the lamp was about 15.66 mm and the Di 5.45 mm. Thus, the plot begins to level to a maximum LPW of 108.6 when the sodium to rare earth ratio is about 48.

The color rendering index (CRI) is an indication of a lamp's ability to show individual colors relative to a standard. This value is derived from a comparison of the lamp's spectral distribution compared to a standard (typically a black body) at the same color temperature. There are fourteen special color rendering indices (Ri where i=1-14) which define the color rendering of the light source when used to illuminate standard color tiles. The general color rendering index (Ra) is the average of the first eight special color rendering indices (which correspond to non-saturated colors) expressed on a scale of 0-100. Unless otherwise indicated, color rendering is expressed herein in terms of the Ra. The color rendering index can be at least 50, in some embodiments, at least 55, and in specific embodiments, about 65 or greater.

Higher efficiency of the exemplary embodiment is achieved due to dose composition and amount added to the arc tube. The design requirement of a relatively low Ra allows for dose weight to be held to a minimum. Low halide dose weight and the resulting low halide vapor pressure may lead to an increase in efficiency. The requirement of a low Ra may allow for dose composition to favor higher amounts of the more efficacious species, such as sodium halide, and lower amounts of the less efficacious species, such as lanthanum halide.

The source of available oxygen is one which, under the lamp operating conditions, makes oxygen available for reaction with other fill components to form WO₂X₂. The source of available oxygen may be an oxide which is unstable under lamp operating temperatures, such as an oxide of tungsten, free oxygen gas (O₂), water, molybdenum oxide, mercury oxide, dioxides of lanthanum, cerium, neodymium, samarium, praseodymium, or combination thereof. The oxide of tungsten may have the general formula WOₙXₘ, where n is at least 1, m can be 0, and X is as defined above. Exemplary tungsten oxides include WO₃, WO₂, and tungsten oxyhalides, such as WO₂I₂. The source of available oxygen may be present in the fill expressed in terms of its O₂ content at, for example, from about 0.1 μmol/cm , e.g., from 0.2-3.0 μmol/cm³ and in one embodiment, from 0.2-2.0 μmol/cm³. As will be appreciated, certain oxides do not decompose readily to form available oxygen under lamp operating conditions, such as cerium oxide (Ce₂O₃) and calcium oxide, and thus do not tend to act effectively as sources of oxygen. In general, most oxides of rare earth elements (RE₂O₃) are not suitable sources of available oxygen as they are stable at lamp operating temperatures.

In one embodiment, the tungsten electrode is partially oxidized to form tungsten oxide, e.g., a spot on its surface is thermally oxidized prior to insertion into the lamp, to provide the source of available oxygen. In other embodiments, comminuted tungsten oxide, such as tungsten oxide chips, may be introduced in the fill.

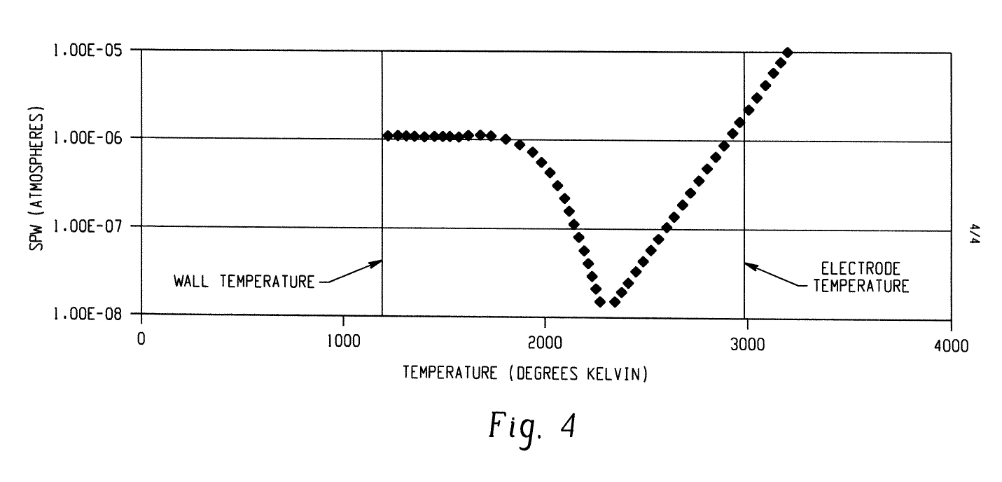

FIG. 4 illustrates theoretical thermodynamic calculations for the solubility of tungsten species vs. temperature for 0.025 mg of WO₃ added to the fill as a source of available oxygen. SPW represents the summed pressures in atmospheres of all tungsten species present in vapor form. As can be seen from FIG. 2, the plot passes through a trough where the solubility is lowest (e.g., at SPW min.). The present exemplary embodiment takes advantage of this trough by selecting a tungsten oxide concentration such that the electrode tip temperature falls closer to the trough, i.e., a lower SPW, than the wall. In general, the SPW at the electrode tip (or wherever on the electrode solubility is lowest) should be no more than 90% of the SPW at the wall to encourage regeneration. Thus, for example, with a WO₃ dose of 0.025 mg, where the wall temperature is about 1200K during operation and the tip temperature is about 3000K, the SPW at the electrode tip 28, 30 is lower than at the wall 32.

As described in various aspects, the lamp is able to simultaneously satisfy photometric targets without compromising targeted reliability or lumen maintenance. Some additional photometric properties that are desirable in a lamp design include CCT, and dCCy.

Correlated Color Temperature (CCT) is defined as the absolute temperature, expressed in degrees Kelvin (K), of a black body radiator when the chromaticity (color) of the black body radiator most closely matches that of the light source. CCT may be estimated from the position of the chromatic coordinates (u, v) in the Commission Internationale de l'Eclairage (CIE) 1960 color space. From this standpoint, the CCT rating is an indication of how “warm” or “cool” the light source is. The higher the number, the cooler the lamp. The lower the number, the warmer the lamp. The exemplary lamp may provide a correlated color temperature (CCT) between for example, about 2700K and about 4500K, about 3300K and about 3200K, e.g., 3000K. For example, in one embodiment, the lamp includes a fill containing calcium halide, wherein in operation, the lamp operates at a correlated color temperature (CCT) of at least about 3,000K. In another embodiment, the lamp includes a fill containing strontium halide, wherein in operation, the lamp operates at a correlated color temperature (CCT) of at least about 4,000K. The present invention has been described by way of the above embodiments. It should be appreciated, however, that the present invention is in no way limited to the specific embodiments described above. Various modifications including fills and temperatures may be modified.

dCCy is the difference in chromaticity of the color point on the Y axis (CCY), from that of the standard black body curve. The exemplary embodiment may have a dCCy of greater than about −0.015 but less than about +0.005 with respect to the black body locus, and in one specific embodiment, the lamp lies directly on the black body locus, i.e. dCCy=0.000.

All of these ranges may be simultaneously satisfied in the present lamp design. Unexpectedly, this can be achieved without negatively impacting lamp reliability or lumen maintenance. Thus, for example, the exemplary lamp may have a lumen maintenance of approximately 80% or better at 12,000 hours, e.g., at a external wall temperature which is no greater than 1525K. Typical current art lamps are less 65% at 12,000 hours.

The invention has been described with reference to the preferred embodiments. Obviously, modifications and alterations will occur to others upon reading and understanding the preceding detailed description. It is intended that the invention be construed as including all such modifications and alterations.

Having thus described the invention, it is now claimed:

1. A lamp comprising:
a discharge vessel;
electrodes extending into the discharge vessel,
an ionizable fill sealed within the vessel, the fill including:
an inert gas, a halide component including:
a sodium halide,
a thallium halide,
at least one of a calcium halide and a strontium halide, and
at least one of a rare earth halide selected from the group consisting of lanthanum, cerium, praseodymium, neodymium, and samarium, and combinations thereof.

2. The lamp of claim 1, wherein an aspect ratio of the discharge tube is satisfied by:
2.0<EA/Di<4.8
where EA=a distance between the electrodes, and
Di=an inner diameter of the discharge vessel.

3. The lamp of claim 2, wherein
2.5<EA/Di<4.0.

4. The lamp of claim 1, wherein a molar ratio of sodium halide to rare earth halide in the fill is satisfied by:
18≦Na/Re≦36.
where Na=moles of sodium halide in the fill, and
Re=moles of rare earth halide in the fill.

5. The lamp of claim 4, wherein
20≦Na/Re≦40.

6. The lamp of claim 1, further comprising a source of available oxygen in the discharge vessel.

7. The lamp of claim 6, wherein the source of available oxygen decomposes to form available oxygen.

8. The lamp of claim 6, wherein the source of available oxygen comprises a solid metal oxide.

9. The lamp of claim 8, wherein the solid metal oxide is an oxide of tungsten.

10. The lamp of claim 9, wherein the tungsten oxide is present in the fill at a concentration of at least 0.1 micromoles O₂/cm³.

11. The lamp of claim 9, wherein the tungsten oxide is present in the fill at a concentration of from about 0.2-3.0 micromoles O₂/cm³.

12. The lamp of claim 1, wherein the rare earth halide is lanthanum halide.

13. The lamp of claim 1, wherein the fill is free of all rare earth halides other than halides of lanthanum, praseodymium, neodymium, samarium, and cerium.

14. The lamp of claim 1, wherein the fill is free of halides of holmium, thulium, dysprosium, erbium, lutetium, yttrium, ytterbium, terbium, scandium, and magnesium.

15. The lamp of claim 1, wherein the halide component is selected from the group consisting of chlorides, bromides, iodides and combinations thereof.

16. The lamp of claim 1, wherein the halide component is an iodide.

17. The lamp of claim 1, wherein the fill comprises:
70.5-75.0 mol % of sodium halide,
20.5-21.5 mol % of calcium halide,
2.0-4.0 mol % of rare earth halide, and
1.0-5.0 mol % of thallium halide.

18. The lamp of claim 1, wherein the lamp simultaneously satisfies the following targets:
a wall loading of less than 33 W/cm²;
a color rendering index (CRI) of at least 65;
a lumen output at about 100 hours of at least 105 LPW; and
a operating voltage (Vop) of less than 110 volts.

19. The lamp of claim 1, wherein the lamp simultaneously satisfies the following targets:
a wall loading of less than 33 W/cm₂;
a color rendering index (CRI) of at least 65;
a lumen output at about 100 hours of at least 105 LPW; and
a operating voltage (Vop) of less than 105 volts.

20. The lamp of claim 18, wherein the lamp further satisfies a lumen maintenance of at least 80% at 12,000 hours, at a wall temperature which is no greater than 1525K.

21. The lamp of claim 19, wherein the lamp further satisfies a lumen maintenance of at least 80% at 12,000 hours, at a wall temperature which is no greater than 1440K.

22. The lamp of claim 1, wherein calcium halide is in the fill.

23. The lamp of claim 22, wherein in operation, the lamp operates at a correlated color temperature (CCT) of at least 3,000K.

24. The lamp of claim 1, wherein strontium halide is in the fill.

25. The lamp of claim 24, wherein in operation, the lamp operates at a correlated color temperature (CCT) of at least 4,000K.

26. A method of forming a lamp, comprising:
providing a discharge vessel;
sealing an ionizing fill within the vessel, the fill including;
an inert gas, a halide component including:
a sodium halide,
a thallium halide,
at least one of a calcium halide and a strontium halide,
at least one of a rare earth halide selected from the group consisting of lanthanum, cerium, praseodymium, and neodymium; and
positioning electrodes within the discharge vessel to energize the fill in response to a voltage applied thereto.

27. A lamp comprising:
a discharge vessel:
electrodes extending into the discharge vessel,
an ionizable fill sealed within the vessel, the fill including:
an inert gas, a halide component including:
a sodium halide,
a thallium halide,
at least one of a calcium halide and a strontium halide, and
at least one of a rare earth halide selected from the group consisting of lanthanum, cerium, praseodymium, and neodymium, and combinations thereof; and
wherein an aspect ratio of the discharge tube is satisfied by:
2.0<EA/Di<4.8
where EA=a distance between the electrodes, and
Di=an inner diameter of the discharge vessel.

28. The lamp of claim 27, wherein
2.5<EA/Di<4.0.

29. The lamp of claim 27, wherein a molar ratio of sodium halide to rare earth halide in the fill is satisfied by:
16≦Na/Re≦48
where Na=moles of sodium halide in the fill, and
Re=moles of rare earth halide in the fill.

30. The lamp of claim 27, wherein
20≦Na/Re≦40.
